(19) United States
(12) Patent Application Publication
(10) Pub. No.: US 2007/0172312 A1
(43) Pub. Date: Jul. 26, 2007

(54) Coupling for joining connection tubes of an exercise apparatus

(76) Inventor: Leao Wang, Taiping (TW)

Correspondence Address: KUO-HSIUNG CHIU, 13F., NO.23, JIUN-HO STREET, PEITUN DISTRICT, TAICHUNG, 406, TW

(21) Appl. No.: 11/332,724

(22) Filed: Jan. 17, 2006

(51) Int. Cl. F16B 5/02

(52) U.S. Cl. 403/388

(57) ABSTRACT

A coupling for joining connection tubes of an exercise apparatus, comprising a top and a bottom coupling member for the connection tubes. The top and bottom coupling members are arranged in pairs and correspond in the form to the lower connection tube. The internal diameter of the tube defined by the top and bottom coupling members is substantially greater than the external diameter of the lower connection tube. In this way, the connection tubes can be firmly attached to each other in a vertical or a horizontal position at contact surfaces between the top and bottom coupling members by use of fixing elements so that an excellent interlocking strength between the connection tubes can be ensured.

### BACKGROUND OF THE INVENTION

1. Fields of the Invention

The invention relates to a coupling for joining connection tubes of an exercise apparatus, and more particularly to a coupling that ensures a great connection strength between both connecting tubes and protects them from being unexpectedly loosened when external forces are applied thereto.

2. Description of the Related Art

It is learned that the main body of the common exercise apparatuses consists of metal tubes that are joined (e.g. welded, clamped, screwed, etc.) either in a vertical or in a horizontal direction. The invention only involves the screwed connection. The screwed connection allows a detachable possibility of the main body of the exercise apparatus for facilitating the packaging and transporting work by minimizing the dimensions of the whole exercise apparatuses. This is common knowledge so that no further descriptions thereto are given hereinafter.

However, the main body of the exercise apparatus is commonly loaded to a great extent. For example, it has to bear the weight of the operator with kicking, pulling, pushing, jumping, running actions. Therefore, the screwed joint strength at the screwed position is very important. Otherwise, the main body of the exercise apparatus could get loose or even be taken apart.

### SUMMARY OF THE INVENTION

In view of the drawbacks of the structure of the prior art, the inventor of the present invention based on years of experience in the related industry to conduct extensive researches, and finally invented a coupling for joining connection tubes of an exercise apparatus. Therefore, it is a primary object of the invention to employ the corresponding top and bottom coupling members on the connection tubes. The internal diameter of the tube defined by the top and bottom coupling members is substantially greater than the external diameter of the lower connection tube. In this way, the connection tubes can be firmly attached to each other at contact surfaces between the top and bottom coupling members by use of fixing elements. Therefore, an excellent interlocking strength between the connection tubes can be ensured to provide the fixing elements with sufficient resistant ability against all external force.

### BRIEF DESCRIPTION OF THE DRAWINGS

The accomplishment of this and other objects of the invention will become apparent from the following description and its accompanying drawings of which:

FIG. 1 is a perspective exploded view of a first embodiment of the present invention;

FIG. 2 is a perspective view of the first embodiment of the present invention according to FIG. 1 after assembly;

FIG. 3 is a schematic drawing of the first embodiment of the present invention according to FIG. 1 after assembly;

FIG. 4 is a cutaway view of the first embodiment of the present invention according to FIG. 3 before fixing elements are tightened;

FIG. 5 is a cutaway view of the first embodiment of the present invention according to FIG. 3 after the fixing elements are tightened;

FIG. 6 is a schematic drawing of a second embodiment of the present invention before assembly;

FIG. 7 is a schematic drawing of the second embodiment of the present invention after assembly; and

FIG. 8 is a perspective exploded view of a conventional coupling for joining tubes of an exercise apparatus.

### DETAILED DESCRIPTION OF THE PREFERRED EMBODIMENT

The technical characteristics, features and advantages of the present invention will become apparent from the following detailed description taken with the accompanying drawing.

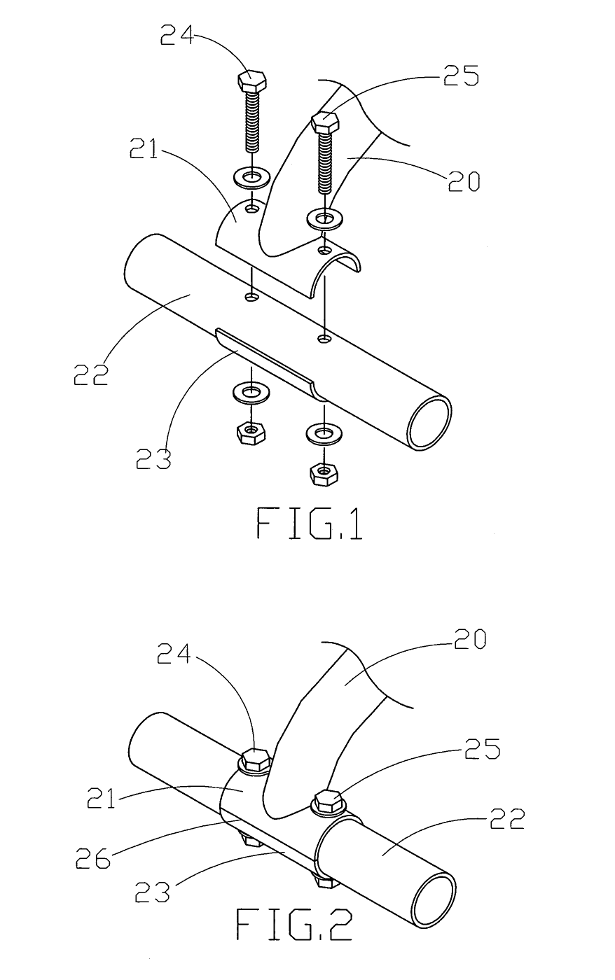

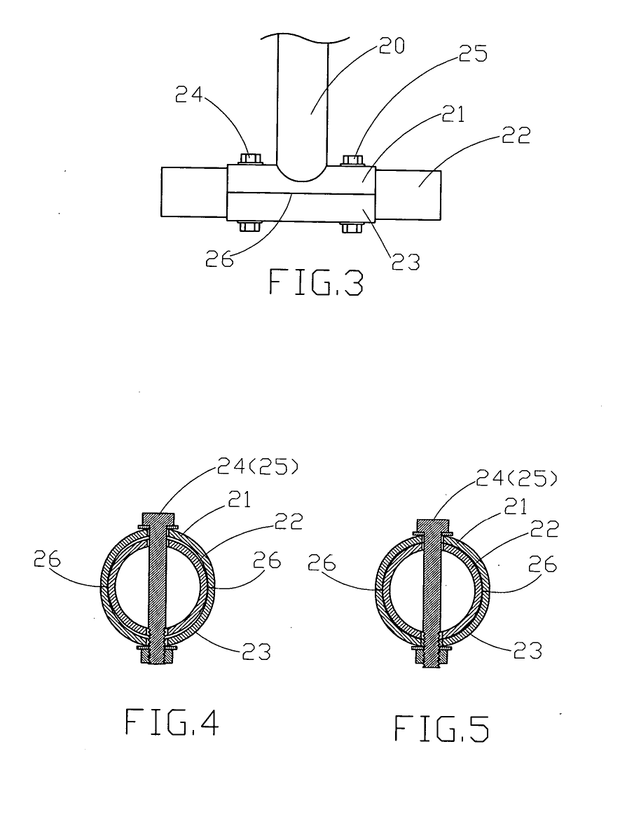

Referring to FIGS. 1 to 3, a preferred embodiment in accordance with the invention is provided for the vertical attachment of an upper and a lower connection tube 20, 22. As shown in FIGS. 1 and 3, the connection tubes 20, 22 have a top and a bottom coupling member 21, 23, respectively. The top and bottom coupling members 21, 23 are arranged in pairs and correspond in their form to the lower connection tube 22. The internal diameter of the tube defined by the top and bottom coupling members 21, 23 is substantially greater than the external diameter of the lower connection tube 22. In this way, the connection tubes 20, 22 can be firmly attached to each other at contact surfaces 26 between the top and bottom coupling members 21, 23 by use of fixing elements 24, 25. Therefore, an excellent interlocking strength between the connection tubes 20, 22 can be ensured.

Referring to FIGS. 4 and 5, a gap between the lower connection tube 22 and the coupling members 21, 23 is present since the internal diameter of the tube defined by the top and bottom coupling members 21, 23 is greater than the external diameter of the lower connection tube 22 before the fixing elements 24, 25 are tightened. Meanwhile, the contact surfaces 26 between the top and bottom coupling members 21, 23 have been attached to each other. After the fixing elements 24, 25 are tightened, the contact surfaces 26 between the top and bottom coupling members 21, 23 are forced in a firm connection state, thereby creating an elongated attachment surface that can be resistant against a very large loading.

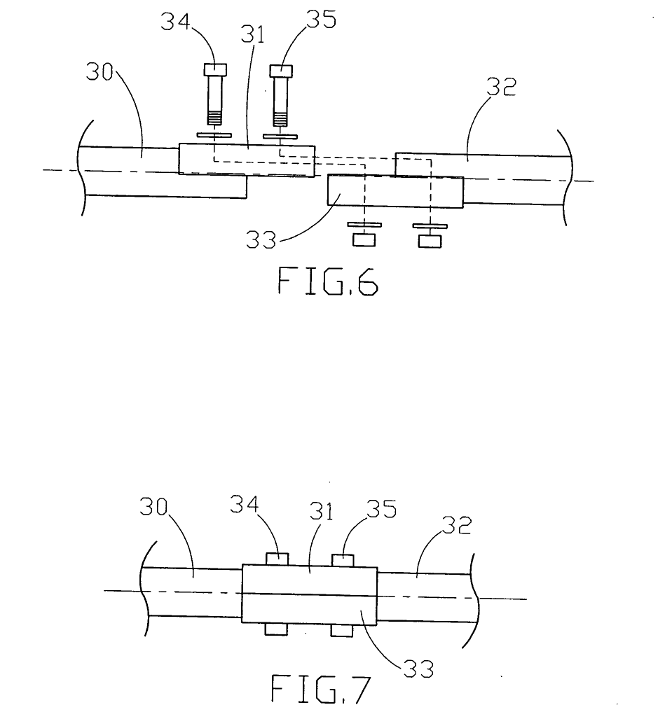

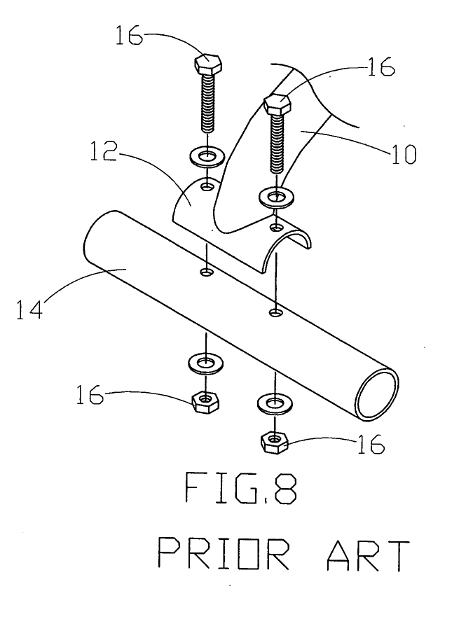

Referring to FIGS. 6 to 7, another preferred embodiment in accordance with the invention is provided for the horizontal attachment of two connection tubes 30, 32. As shown in FIGS. 6 and 7, the connection tubes 30, 32 each have a top and a bottom coupling member 31, 33 laterally extending toward each other, respectively. The coupling members 31, 33 are arranged in pairs and correspond in their form to the connection tube 32. The internal diameter of the tube defined by the top and bottom coupling members 31, 33 is substantially greater than the external diameter of the connection tube 32. In this way, an expected effect can be also achieved by use of fixing elements 34, 35 to join the connection tubes 30, 32 through both of the coupling members 31, 33.

Based on the above-mentioned configuration, an excellent connection effect can be ensured no matter which contour (e.g. circular, oval, rectangular, square, polygon) the connection tubes have.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A coupling for joining connection tubes of an exercise apparatus, comprising a top and a bottom coupling member for the connection tubes, the top and bottom coupling members being arranged in pairs and corresponding in the form to the lower connection tube, the internal diameter of the tube defined by the top and bottom coupling members being substantially greater than the external diameter of the lower connection tube,
whereby the connection tubes can be firmly attached to each other in a vertical position at contact surfaces between the top and bottom coupling members by use of fixing elements so that an excellent interlocking strength between the connection tubes can be ensured.

2. A coupling for joining connection tubes of an exercise apparatus, comprising a top and a bottom coupling member for the connection tubes, the top and bottom coupling members laterally extending toward each other, corresponding in the form to the lower connection tube, and being arranged in pairs, the internal diameter of the tube defined by the top and bottom coupling members being substantially greater than the external diameter of the lower connection tube,
whereby the connection tubes can be firmly attached to each other in a horizontal position at contact surfaces between the top and bottom coupling members by use of fixing elements so that an excellent interlocking strength between the connection tubes can be ensured.
